(19) United States
(12) Patent Application Publication
(10) Pub. No.: US 2023/0267901 A1
(43) Pub. Date: Aug. 24, 2023

(54) SIGNAL GENERATION DEVICE, ELECTRONIC MUSICAL INSTRUMENT, ELECTRONIC KEYBOARD DEVICE, ELECTRONIC APPARATUS, AND SIGNAL GENERATION METHOD

(71) Applicant: YAMAHA CORPORATION, Hamamatsu-shi (JP)

(72) Inventor: Akinobu SHIBUYA, Hamamatsu-shi (JP)

(21) Appl. No.: 18/310,600

(22) Filed: May 2, 2023

Related U.S. Application Data
(63) Continuation of application No. PCT/JP2021/040722, filed on Nov. 5, 2021.

(30) Foreign Application Priority Data
Nov. 12, 2020 (JP) 2020-188794

(51) Int. Cl. G10H 1/053

(52) U.S. Cl. CPC G10H 1/053; G10H 2210/225; G10H 2220/221; G10H 2220/265

(57) ABSTRACT

According to an embodiment, a signal generation device includes a memory storing a program and a processor communicatively connected to the memory and executing the program to function as a signal generating unit and a sound generation control unit. The signal generating unit generates a sound signal in response to operation of a plurality of operators. The plurality of operators includes a first operator and a second operator. The sound generation control unit controls a sound generation form of a second sound signal generated in response to a second operation of the second operator following a first operation, based on a duration of the first operation of the first operator.

### CROSS-REFERENCE TO RELATED APPLICATIONS

This application is a Continuation of International Patent Application No. PCT/JP2021/040722, filed on Nov. 5, 2021, which claims the benefit of priority to Japanese Patent Application No. 2020-188794, filed on Nov. 12, 2020, the entire contents of which are incorporated herein by reference.

### FIELD

The present disclosure relates to a technique for generating a sound signal.

### BACKGROUND

A sound generation in an electronic keyboard musical instrument can be variously controlled. One of sound generation controls is a portamento process. In the case where a normal sound generation process is executed, when two different keys are operated in succession, a sound generation of a pitch corresponding to each key is executed in sequence. On the other hand, in the case where the portamento process is executed, the pitch is controlled so as to change smoothly between each sound. Techniques have also been developed to variously change the manner in which the pitch is changed smoothly (for example, Japanese Laid-Open Patent Publication No. H1-214899).

### SUMMARY

According to an embodiment, a signal generation device including a generating unit and a sound generation control unit is provided. The generating unit generates a sound signal according to an operation to a plurality of operators. The plurality of operators includes a first operator and a second operator. The sound generation control unit controls the sound generation form of the sound signal generated according to a second operation to the second operator following a first operation, based on a duration of the first operation to the first operator.

### BRIEF DESCRIPTION OF DRAWINGS

FIG. 1 is a diagram showing an appearance of an electronic keyboard device according to an embodiment.

FIG. 2 is a diagram showing a configuration of an electronic keyboard device according to an embodiment.

FIG. 3 is a flowchart showing a sound signal generating method by a portamento process according to an embodiment.

FIG. 4 is a flowchart showing a pitch transition process according to an embodiment.

FIG. 5 is a diagram showing an example of a pitch change according to an embodiment.

FIG. 6 is a diagram showing an example of a pitch change according to an embodiment.

### DESCRIPTION OF EMBODIMENTS

In general, the portamento process can be enabled or disabled by operating a control button or the like arranged in an electronic keyboard musical instrument. However, it is difficult to perform such an operation during performance. In particular, controlling by the control button or the like makes performance even more difficult if it is desired to disable the portamento process in part of the performance using the portamento process (such as a part in the middle of one phrase).

One of the objects of the present disclosure is to control the portamento process based on a musical playing technique.

Hereinafter, an electronic keyboard device according to an embodiment of the present disclosure will be described in detail with reference to drawings. The following embodiment is an example of embodiments of the present disclosure, and the present invention should not be construed as being limited to this embodiment. In the drawings referred to in the present embodiment, the same or similar parts are denoted by the same symbols or similar symbols (only denoted by A, B, and the like after the numerals), and repetitive descriptions thereof may be omitted. Dimensional ratios in the drawings may be different from actual ratios for convenience of explanation, or part of the configuration may be omitted from the drawings.

### 1. Configuration of Electronic Keyboard Device

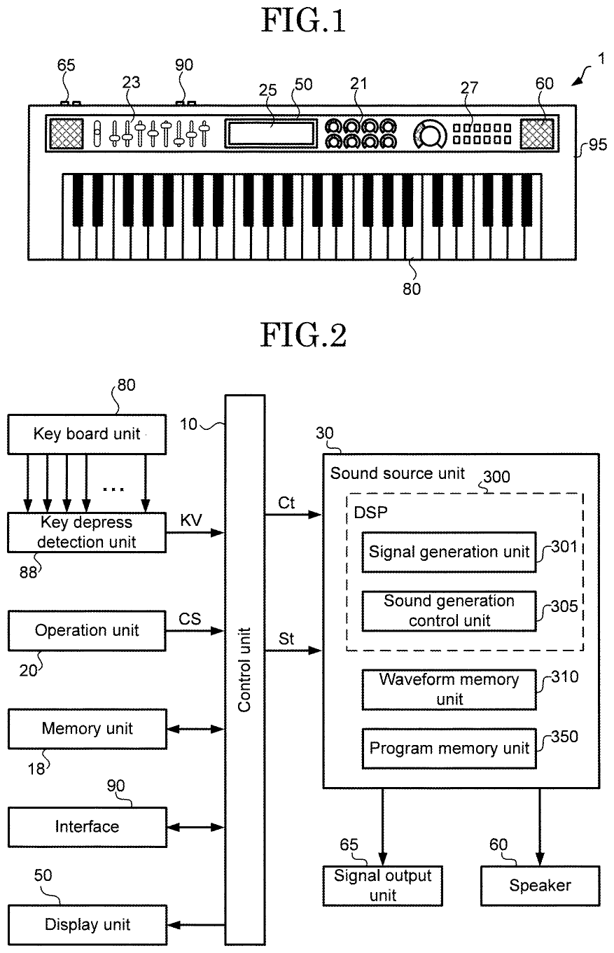

FIG. 1 is a diagram showing an appearance of an electronic keyboard device according to an embodiment. An electronic keyboard device 1 is a synthesizer having a keyboard unit 80 including a plurality of keys rotatably supported by a housing 95. The key is an example of an operator that accepts an input of a performance operation by a user. The electronic keyboard device 1 generates a sound signal according to an operation of the key by the user or a control by a sequencer. This sound signal may be given a predetermined sound effect. A process of imparting the sound effect includes a portamento process.

The portamento process in this example switches to the control in a different sound generation form when a predetermined playing technique (key depression operation) is detected while performing the control in the sound generation form by a general portamento. In this example, for example, a tolyl is assumed as a predetermined playing technique. When a trill is detected, the sound generation form is controlled so that a transition of a pitch in the portamento takes place in a short time. An electronic keyboard device 1 for realizing such control of the sound generation form will be described.

FIG. 2 is a diagram showing a configuration of an electronic keyboard device according to an embodiment. The electronic keyboard device 1 includes a control unit 10, a memory unit 18, an operation unit 20, a sound source unit 30, a display unit 50, a speaker 60, a signal output unit 65, a keyboard unit 80, a key depression detection unit 88, and an interface 90.

The memory unit 18 is a memory device such as a nonvolatile memory, and includes an area for storing a control program executed by the control unit 10. The control program may be provided from an external device. When the control program is executed by the control unit 10, various functions are realized in the electronic keyboard device 1.

The operation unit 20 includes an operation device such as a knob, a slider, a touch sensor, and a button, and receives an instruction from the user to the electronic keyboard device 1. The operation unit 20 outputs operation signal CS corresponding to the received user's instruction to the control unit 10.

The display unit 50 includes a display device such as a liquid crystal display, and displays various images under the control of the control unit 10. A touch panel may be configured by combining a touch sensor with the display unit 50.

The speaker 60 amplifies and outputs the sound signal supplied from the sound source 30, thereby producing the sound corresponding to the sound signal.

The signal output unit 65 includes a terminal for outputting the sound signal supplied from the sound source unit 30 to an external device.

The key depression detection unit 88 includes a sensor that outputs a detection signal KV corresponding to a depressed key and a depressed amount of the key to the control unit 10.

The interface 90, in this example, includes a terminal for connecting an external device such as a controller to the electronic keyboard device 1. The interface 90 may include a terminal for transmitting and receiving MIDI data.

The control unit 10 is an example of a computer including an arithmetic processor such as a CPU and a memory device such as a RAM and a ROM. The control unit 10 executes a control program stored in the memory unit 18 by the CPU, and implements various functions in the electronic keyboard device 1 in accordance with instructions described in the control program. For example, the control unit 10 generates a sound source control signal Ct based on the detection signal KV, and generates a setting signal St based on the operation signal CS.

The sound source control signal Ct includes information for controlling the generation of sounds such as a note number, a note-on, and a note-off, and is used to generate a sound signal in the sound source unit 30. The setting signal St is used to set various parameter values such as sound effects for generating a sound signal in the sound source unit 30. The setting signal St includes information for setting an operation mode of the sound generation process to either a mode for executing a portamento process described later or a mode for executing a normal process, and information for setting a parameter used in the portamento process. Hereinafter, a mode for executing the portamento process may be referred to as a portamento performance mode. Hereinafter, a mode for executing the normal process may be referred to as a normal performance mode.

In this example, the normal performance mode is an operation mode for generating sound in a sound generation form that does not use the portamento process. That is, in the normal performance mode, the sound signal corresponding to the pitch of the key is generated every time the key is operated, but the sound generation form of the portamento process in which the pitch gradually changes during each sound generation is not adopted. In other words, the normal performance mode can be said to be an operation mode in which a control of the sound generation form by the portamento process is disabled.

Parameters used in the portamento process are, in this instance, a switching threshold Tth and a speed (low speed Ls or high speed Hs) at which a pitch in the portamento is changed. The switching threshold Tth is a parameter that are used when the trill is detected as a playing technique. The low speed Ls is a parameter relevant to the speed at which the pitch in the portamento process is changed. The high speed Hs is a parameter relevant to a speed at which the pitch in the portamento process is changed when the trill is detected. The low speed Ls is smaller than the high speed Hs. A use of these parameters will be described later.

The sound source unit 30 includes a DSP (Digital Signal Processor) 300, a waveform memory unit 310, and a program memory unit 350, and is an example of a signal generation device for generating a sound signal. The waveform memory unit 310 stores waveform data for generating the sound signal. The program memory unit 350 stores a program executed by the DSP 300. This program may be provided from an external device.

The DSP 300 generates a sound signal based on the sound source control signal Ct and the setting signal St supplied from the control unit 10. The DSP 300 supplies the generated sound signal to the signal output unit 65, and may further supply the sound signal to the speaker 60. The DSP 300 executes the program stored in the program memory unit 350, and implements various functions in the sound source unit 30 in accordance with instructions described in the program. All or some of the functions of the sound source unit 30 may be realized by executing the program in the control unit 10.

### 2. DSP Functions

Functions realized by DSP 300 in the sound source unit 30 will be described. When DSP 300 executes the program, the signal generating unit 301 and the sound generation control unit 305 are implemented in the sound source unit 30. The signal generating unit 301 reads the waveform data from the waveform memory unit 310 based on the sound source control signal Ct, and generates a sound signal based on the waveform data and various parameters set based on the setting signal St. The sound generation control unit 305 controls a method of generating a sound signal in the signal generating unit 301. In this embodiment, when the normal performance mode and the portamento performance mode are switched based on the setting signal St, the sound generation control unit 305 controls the signal generating unit 301 to generate a sound signal in a sound generation form corresponding to the respective modes.

### 3. Portamento Process Flow

Next, a process executed by the sound source unit 30 in the case where the operation mode is set to the portamento performance mode based on the setting signal St will be described. The flow described below continues until the portamento performance mode is disabled.

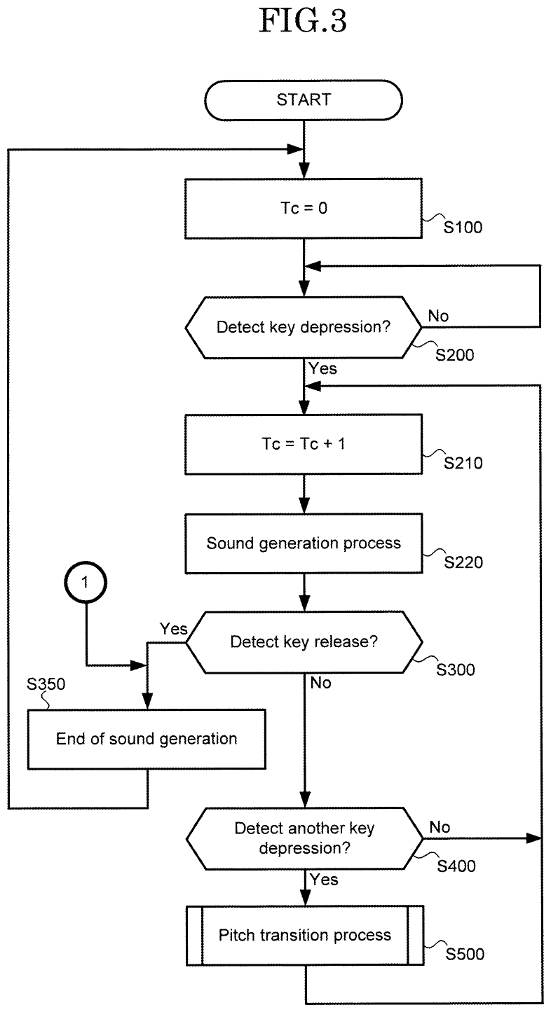

FIG. 3 is a flowchart showing a method of generating a sound signal by the portamento process according to an embodiment. When the operation mode is set to the portamento performance mode, the sound source unit 30 sets the count-value Tc for measuring the key depression time to 0 (step S100). The sound source unit 30 waits until a key depression is detected (step S200; No). When the key depression is detected (step S200; Yes), the sound source unit 30 adds 1 to the count value Tc (step S210), and executes a sound generation process corresponding to the key depression (step S220). Specifically, a sound signal corresponding to the pitch of the depressed key is generated. The sound source unit 30 continues the process of the step S210 and S220 for the depressed key while neither the key release nor the other key depression is detected (step S300; No, step S400; No). That is, the sound source unit 30 adds 1 to the count value Tc (step S210), and generates a sound signal so as to continue sound generation (step S220).

In the case where a key release is detected (step S300; Yes), the sound source unit 30 ends the sound generation process (step S350), returns to the step S100, and continues the process. In the case where another key depression is detected prior to the key release (step S400; Yes), the sound source unit 30 executes a pitch transition process (step S500).

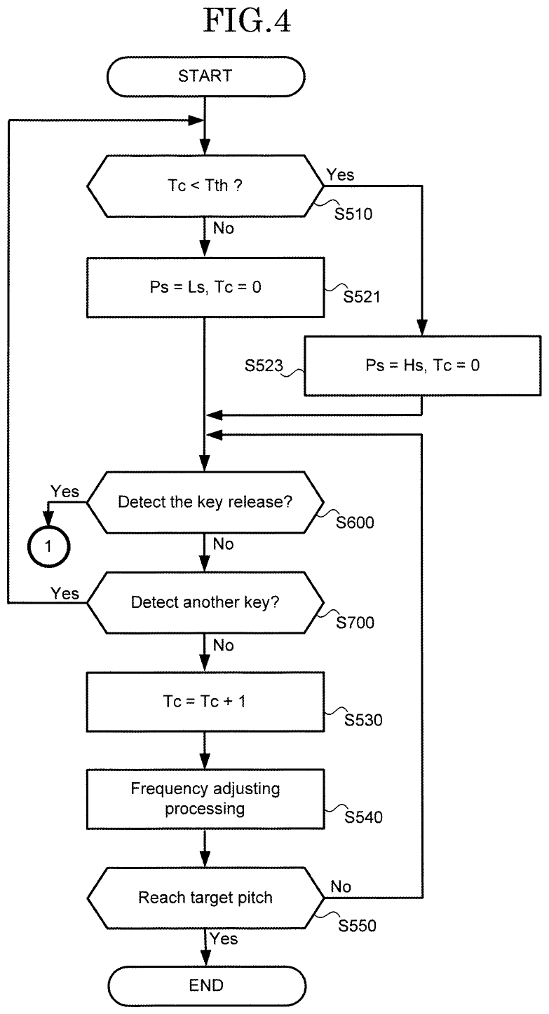

FIG. 4 is a flowchart showing a pitch transition process according to an embodiment. When the pitch transition process is started, the sound source unit 30 determines whether or not the count value Tc is smaller than the switching threshold Tth (step S510). Since the count value Tc is increasing while the key is depressed, it corresponds to a duration of the depressed state. Therefore, in the following explanation, the count value Tc may be referred to as a duration Tc.

In the case where the duration Tc is equal to or greater than the switching threshold Tth (step S510; No), the sound source unit 30 sets the duration Tc to 0 in order to measure the time during which the new key depression is continued, while setting a pitch change speed Ps to a low speed Ls (step S521). On the other hand, in the case where the duration Tc is less than the switching threshold Tth (step S510; Yes), the sound source unit 30 sets the duration Tc to 0 in order to measure the time during which the new key depression is continued, while setting the pitch change speed Ps to a high speed Hs (step S523).

The sound source unit 30 executes the process of steps S530 to S550 described below for the depressed key while neither the key release nor the other key depression is detected (step S600; No, step S700; No). In the case where another key depression is detected prior to the release of the key (step S700; Yes), the sound source unit 30 returns to step S510 and continues the process. In the case where a key release is detected (step S600; Yes), the sound source unit 30 ends the sound generation process (step S350 in FIG. 3), returns to the step S100 shown in FIG. 3, and continues the process.

The sound source unit 30 adds 1 to the count value Tc (step S530), and performs a process of adjusting the frequency of the sound signal toward a target pitch at a speed corresponding to a pitch change speed Ps (step S540). The target pitch is the pitch corresponding to the key detected in the step S400.

The sound source unit 30 continues the process of step S530 and S540 until the pitch of the sound signal reaches the target pitch (step S550; No). That is, the sound source unit 30 adds 1 to the count value Tc (step S530), and performs a process of adjusting the frequency of the sound signal toward the target pitch at a speed corresponding to the pitch change speed Ps (step S540). In the case where the pitch of the sound signal has reached the target pitch (step S550; Yes), the sound source unit 30 ends the pitch transition process, and returns to the step S210 shown in FIG. 3 to continue the process.

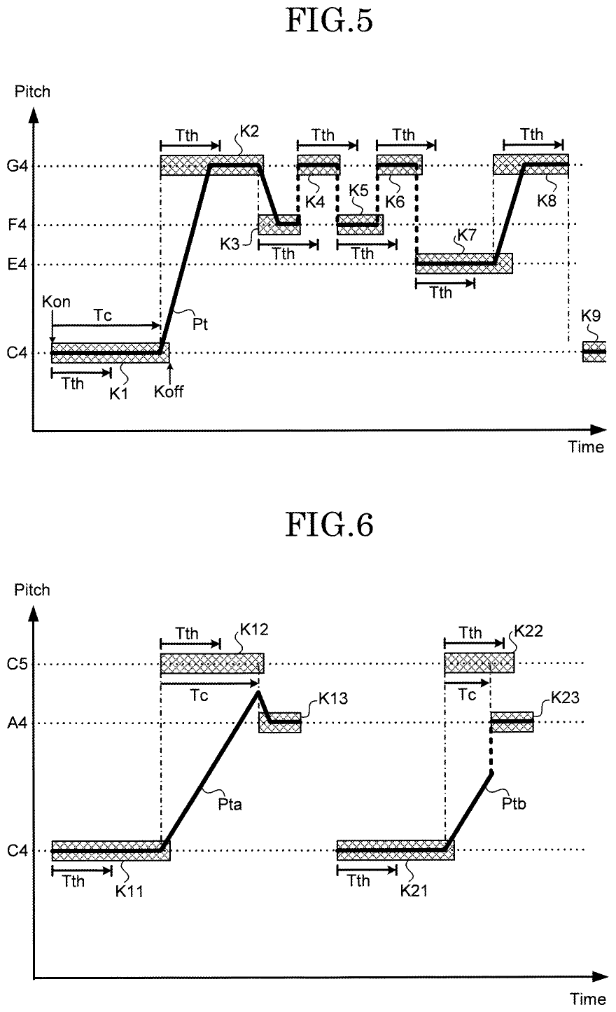

In this way, when another key depression is detected after the first key depression and prior to the key release, the pitch of the sound signal shifts toward the target pitch at a speed corresponding to the pitch change speed Ps. As described above, the pitch change speed Ps is set to either the low speed Ls or the high speed Hs according to the duration Tc. In the case where the pitch change speed Ps is set to the low speed Ls, the sound source unit 30 generates a sound signal such that the pitch gradually changes, as in a sound generation form by a typical portamento process. On the other hand, in the case where the pitch change speed Ps is set to the high speed Hs, the sound source unit generates a sound signal so as to change the pitch abruptly, and as in the sound generation form in which the portamento process is not substantially executed. An example of the change in pitch due to the control of the sound generation form will be described with reference to FIG. 5 and FIG. 6.

FIG. 5 is a diagram showing an example of a pitch change according to an embodiment. When the key operations K1 to K9 corresponding to the key depressions are inputted, a pitch Pt of the sound signal changes in accordance with the portamento process described above. In the example of FIGS. 5, K1 and K9 correspond to the key of C4, K2, K4, K6, and K8 correspond to the key of G4, K3 and K5 correspond to the key of F4, and K7 corresponds to the key of E4. In each key operation, a range from a key depression (Kon) timing to a key release (Koff) timing is indicated by a strip-shaped image.

The key operation K1 generates a sound signal at the pitch of C4. Since the key operation K2 is performed prior to the completion of the key operation K1, a period from a key depression timing of the key operation K1 to a key depression timing of the key operation K2 is counted as the duration Tc. Since the duration Tc is greater than or equal to the switching threshold Tth, the pitch change speed Ps is set to the low speed Ls. The pitch Pt starts to change from C4 to G4 in the low speed Ls from the key depression timing of the key operation K2. In a relationship between the key operation K2 and the key operation K3, similarly to the relationship between the key operation K1 and the key operation K2, the pitch change speed Ps is set to the low speed Ls. Therefore, the pitch Pt starts to change from G4 to F4 in the low speed Ls from the key depression timing of the key operation K3.

Since the duration Tc of the key operation K3, that is, the duration Tc from the key depression timing of the key operation K3 to the key depression timing of the key operation K4 is less than the switching threshold Tth, the pitch change speed Ps is set to the high speed Hs. The pitch Pt starts to change from F4 to G4 in the high speed Hs from a key depression timing of the key operation K4. As described above, the high speed Hs should be set as a value larger than the low speed Ls, but in this case, the high speed Hs is set as a value much larger than the low speed Ls. Therefore, the pitch Pt changes to G4 substantially simultaneously with the key depression of the key operation K4. In other words, the transition time until the pitch Pt changes from F4 to G4 is approximately 0. In FIG. 5, part of the pitch Pt that varies in the high speed Hs is indicated by a dashed line. The same applies to a pitch Ptb shown in FIG. 6.

The transition time may be 0 or may be a minimum controllable time. The transition time of 0 may be a time corresponding to the control in the case where the control of the sound generation form in the portamento performance mode is disabled. Specifically, it is indicated that the same sound generation timing is reproduced between when the transition time is 0 in the portamento performance mode and when in the normal performance mode.

Durations Tc of the key operations K4 to K7 are all less than the switching threshold Tth. Therefore, the pitch Pt is changed in the order of G4, F4, G4, and E4 in the high speed Hs in accordance with the key depression timing of the key operations K4, K5, K6, and K7. Since the duration Tc of the key operation K7 is equal to or larger than the switching thresholds Tth, the pitch Pt starts to change from E4 to G4 in the low speed Ls from a key depression timing of the key operation K8. The key depression timing of the key operation K9 is later than the key release timing of the key operation K8. Therefore, the sound generation is terminated at the release timing of the key operation K8, and a sound signal corresponding to the pitch of C4 is newly generated at the key depression timing of the key operation K9.

FIG. 6 is a diagram showing an example of a pitch change according to an embodiment. In the embodiment of FIG. 6, K11 and K21 correspond to the key of C4, K12 and K22 correspond to the key of C5, and K13 and K23 correspond to the key of A4. According to a relationship between the key operations K11 and K12 and a relationship between the key operations K21 and K22, a change in pitch is large. Therefore, the target pitch is not reached within the duration Tc of the subsequent key operations K12 and K22.

When a key operation K12 is performed after the key operation K11, a pitch Pta starts to change from C4 to C5 in the low speed Ls from the key operation K12 depression timing. When a key operation K13 is performed prior to the completion of the key operation K12, a period from the key depression timing of the key operation K12 to the key depression timing of the key operation K13 is counted as the duration Tc. Since the duration Tc related to the key operation K12 is equal to or larger than the switching threshold Tth, the pitch change speed Ps is set to the low speed Ls. The pitch Pta starts to change to A4 in the low speed Ls even prior to reaching C5 (the pitch between C4 and C5) from the key depression timing of the key operation K13.

When a key operation K22 is performed after the key operation K21, the pitch Ptb starts to change from C4 to C5 in the low speed Ls from the key operation K22 depression timing. Since a key operation K23 is performed prior to the completion of the key operation K22, the period from the key depression timing of the key operation K22 to the key depression timing of the key operation K23 is counted as the duration Tc. Since the duration Tc of the key operation K22 is less than the switching threshold Tth, the pitch change speed Ps is set to the high speed Hs. The pitch Ptb starts to change to A4 in the high speed Hs from the key depression timing of the key operation K23 even prior to reaching C5 (pitch between C4 and C5). As described above, since the high speed Hs is set to be much larger than the low speed Ls, the pitch Ptb changes to A4 substantially simultaneously with the key depression of the key operation K23.

The key operations K3 to K7 inputted after the key operations K1 and K2 are performances in which the next key is depressed with a short key depression. Such a playing technique corresponds to the trill. In this case, if the pitch Pt gradually changes as in the normal portamento process, the time for changing the pitch Pt is long, and therefore, even if the target pitch cannot be reached or the target pitch can be reached, the time maintained at that pitch is short. For example, the failure to reach the target pitch corresponds to a pitch change in the duration of the key operations K12 and K22 in FIG. 6. For example, even if the target pitch is reached, the short time maintained at the pitch corresponds to a pitch change in the duration of the key operation K2 in FIG. 5. Therefore, the portamento process cannot reproduce an impression of the original sound by a playing technique such as a trill.

It is possible to reproduce an impression of the original sound by controlling the pitch Pt as described above, since it takes almost no time to change the pitch Pt while the playing technique of the trill is performed. In addition, the player can increase the pitch change speed Ps by simply playing with the trill in the portamento playing mode. Therefore, the pitch change speed Ps can be varied by changing the playing technique without having to perform a separate operation (e.g., an operation of the control 20) during the performance.

### Modification

Although an embodiment of the present disclosure has been described above, an embodiment of the present disclosure can be modified into various forms as follows. The embodiment described above and the modifications described below can be applied in combination with each other.

(1) In the portamento performance mode, the change form of the pitch is determined based on a speed at which the pitch changes (the pitch change speed Ps), but may be determined based on a time in which the pitch changes (a time it takes to reach the target pitch, hereinafter referred to as a pitch change time). Instead of setting the pitch change speed Ps to any value of the low speed Ls or the high speed Hs, the pitch change time may be set to any value of the long time or the short time.

It is possible to control the transition time when changing from a first pitch to a second pitch by changing the set value in both the pitch change speed and the pitch change time. According to the embodiment described above, the sound source unit 30 controls a transition period in the pitch change by changing the pitch change speed Ps. According to the modification (1), the sound source unit 30 controls the transition time in the pitch change by changing the value of the pitch change time. In the case where the transition time is controlled by the pitch change speed Ps, the greater the change amount in pitch, the longer the transition time. On the other hand, if the change amount of the pitch is the same, it can be said that the transition time is controlled by the value set in the pitch change speed Ps.

That is, the transition time becomes longer if the pitch change speed Ps is set to the low speed Ls, and the transition time becomes shorter if the pitch change speed Ps is set to the high speed Hs. If the pitch change time is set to a long time, the transition time becomes longer, and if the pitch change time is set to a short time, the transition time becomes shorter. As described above, the sound source unit 30 may control the transition time of the pitch change by the pitch change speed or the pitch change time.

(2) The manner when the pitch is changed in the portamento performance mode may not be a change in a constant speed, but may be changed in a preset manner.

(3) In the process of the portamento performance mode shown in FIG. 3, the sound source unit 30 may execute the pitch transition process without ending the sound generation in the case if another key depression is detected within a predetermined time after detecting the release of the key even if the key release is detected before another key depression is detected. In this case, the duration Tc may be calculated in the same manner as in the embodiment described above, or may be calculated so as to correspond to the time from the key depression to the key release.

(4) The pitch change speed Ps may be set by a predetermined arithmetic expression obtained from the duration Tc instead of being set to either the low speed Ls or the high speed Hs by the duration Tc. For example, the longer the duration Tc, the slower the speed, that is, the longer the transition time.

(5) As a condition for setting the pitch change speed Ps to the high speed Hs in the portamento performance mode, another condition may be added in addition to the case where the duration Tc is less than the switching threshold Tth. For example, another condition may be that keys corresponding to two pitches are operated alternately. For example, in the case where a key corresponding to the first pitch is operated, a key corresponding to the second pitch is operated, and then the key corresponding to the first pitch is operated again, the sound source unit 30 determines that the key corresponding to the first pitch and the key corresponding to the second pitch are alternately operated. In this example, it corresponds to the case where the keys are operated once alternately. After that, in the case where the key corresponding to the second pitch is operated, it is assumed that the keys are operated twice alternately. In the case where the number of times the keys have been alternately operated reaches a predetermined number, the sound source unit 30 may determine that the additional condition is satisfied.

(6) The sound source unit 30 is not limited to the case of being applied to a device including a key as an operator, such as the electronic keyboard device 1, and may be applied to various electronic musical instruments using an operator other than the key. For example, the sound source unit 30 can be applied to, an electronic wind instrument, an electronic stringed instrument, or the like. The operator may be an image displayed on the touch panel. In this case, for example, in an electronic apparatus such as a terminal including a touch panel, such as a smart phone, a configuration for executing a process in the sound source unit 30 may be realized by the CPU (processor) executing the program. Further, the electronic apparatus may display an image imitating an operator such as a key on a touch panel as an object of a performance operation.

The above is the description of the modification.

As described above, according to an embodiment, a signal generation device including a memory storing a program and a processor communicatively connected to the memory and executing the program to function as a signal generating unit and a sound generation control unit is provided. The generating unit generates a sound signal in response to operation of a plurality of operators. The plurality of operators includes a first operator and a second operator. The sound generation control unit controls a sound generation form of a second sound signal generated in response to a second operation of the second operator following a first operation of the first operator, based on a duration of the first operation of the first operator. Further, the configuration may be as follows.

The sound generation control unit may control the sound generation form so as to control a transition time for changing a pitch of the second sound signal from a first pitch corresponding to the first operation to a second pitch corresponding to the second operation.

The sound generation control unit may control the transition time to be longer in a case where the duration of the first operation is a second duration longer than a first duration than in a case where the duration of the first operation is the first duration.

In a case where the duration of the first operation is shorter than a predetermined time, the sound generation control unit may control the transition time to a predefined time corresponding to a case where the control of the sound generation form is disabled.

In a case where the duration of the first operation is shorter than a predetermined time and a number of times the first operator and the second operator are alternately operated reaches a predetermined number of times, the sound generation control unit may control the transition time to a predefined time corresponding to a case where the control of the sound generation form is disabled.

In a case where the duration of the first operation is the second duration, the sound generation control unit may control the sound generation form so that the transition time increases as a difference between the first pitch and the second pitch increases.

The sound generation control unit may control the sound generation form so that the difference between the first pitch and the second pitch increases, the transition time increases by keeping a speed of a transition from the first pitch to the second pitch constant.

In a case where the duration of the first operation is the second duration, the sound generation control unit may control the sound generation form so that the transition time is constant regardless of a difference between the first pitch and the second pitch.

In a case where the second operation is started before a completion of the first operation, the duration of the first operation may correspond to a time from a start of the first operation to a start of the second operation.

In a case where the second operation is started within a predetermined time after the completion of the first operation, the duration of the first operation may correspond to a time from the start to the completion of the first operation.

According to an embodiment, an electronic musical instrument including the signal generation device and a plurality of operators including the first operator and the second operator is provided.

According to an embodiment, an electronic keyboard device including the signal generation device and a plurality of keys including the first operator and the second operator is provided.

According to an embodiment, an electronic apparatus including the signal generation device, and a touch panel that is controlled to display a plurality of images including a first image corresponding to a first operator and a second image corresponding to a second operator is provided.

According to an embodiment, a signal generation device including a memory unit storing a program and a processor communicatively connected to the memory and executing the program to generate a first sound signal corresponding to a first operation of a first operator, and generate a second sound signal corresponding to a second operation of a second operator following the first operation of the first operator, the second sound signal being generated in a sound generation form based on a duration of the first operation.

According to an embodiment, a signal generation method including generating a first sound signal corresponding to a first operation of a first operator, and generating a second sound signal corresponding to a second operation of a second operator following the first operation of the first operator, the second sound signal being generated in a sound generation form based on a duration of the first operation is provided.

Generating the second sound signal may include controlling the sound generation form so as to control a transition time for changing a pitch of the second sound signal from a first pitch corresponding to the first operation to a second pitch corresponding to the second operation.

Generating the second sound signal may include controlling the transition time to be longer in the case where the duration of the first operation is the second duration longer than the first duration than in the case where the duration of the first operation is the first duration.

Generating the second sound signal may include controlling the transition time to a predefined time corresponding to a case where the control of the sound generation form is disabled in a case where the duration of the first operation is shorter than a predetermined time.

Generating the second sound signal may include controlling the transition time to a predefined time corresponding to a case where the control of the sound generation form is disabled in a case where the duration of the first operation is shorter than a predetermined time and the number of times the first operator and the second operator are alternately operated reaches a predetermined number of times.

According to an embodiment, a program for causing a computer to execute generating a first sound signal corresponding to a first operation of a first operator, and generating a second sound signal corresponding to a second operation of a second operator following the first operation of the first operator, the second sound signal being generated in the sound generation form based on a duration of the first operation is provided.

What is claimed is:

1. A signal generation device comprising:
a memory storing a program; and
a processor communicatively connected to the memory and executing the program to function as:
a signal generating unit that generates a sound signal in response to operation of a plurality of operators including a first operator and a second operator; and
a sound generation control unit that controls a sound generation form of a second sound signal generated in response to a second operation of the second operator following a first operation of the first operator, based on a duration of the first operation of the first operator.

2. The signal generation device according to claim 1, wherein the sound generation control unit controls the sound generation form so as to control a transition time for changing a pitch of the second sound signal from a first pitch corresponding to the first operation to a second pitch corresponding to the second operation.

3. The signal generation device according to claim 2, wherein the sound generation control unit controls the transition time to be longer in a case where the duration of the first operation is a second duration longer than a first duration than in a case where the duration of the first operation is the first duration.

4. The signal generation device according to claim 2, wherein, in a case where the duration of the first operation is shorter than a predetermined time, the sound generation control unit controls the transition time to a predefined time corresponding to a case where the control of the sound generation form is disabled.

5. The signal generation device according to claim 2, wherein, in a case where the duration of the first operation is shorter than a predetermined time and the first operator and the second operator are alternately operated, the sound generation control unit controls the transition time to a predefined time corresponding to a case where the control of the sound generation form is disabled.

6. The signal generation device according to claim 5, wherein, in a case where a number of times the first operator and the second operator are alternately operated reaches a predetermined number of times, the sound generation control unit controls the transition time to the predefined time corresponding to the case where the control of the sound generation form is disabled.

7. The signal generation device according to claim 3, wherein, in a case where the duration of the first operation is the second duration, the sound generation control unit controls the sound generation form so that the transition time increases as a difference between the first pitch and the second pitch increases.

8. The signal generation device according to claim 7, wherein the sound generation control unit controls the sound generation form so that the difference between the first pitch and the second pitch increases, the transition time increases by keeping a speed of a transition from the first pitch to the second pitch constant.

9. The signal generation device according to claim 3, wherein, in a case where the duration of the first operation is the second duration, the sound generation control unit controls the sound generation form so that the transition time is constant regardless of a difference between the first pitch and the second pitch.

10. The signal generation device according to claim 1, wherein the duration of the first operation corresponds to a time from a start of the first operation to a start of the second operation in a case where the second operation is started before a completion of the first operation.

11. The signal generation device according to claim 1, wherein the duration of the first operation corresponds to a time from a start to a completion of the first operation in a case where the second operation is started within a predetermined time after the completion of the first operation.

12. An electronic musical instrument comprising:
the signal generation device according to claim 1; and
a plurality of operators including the first operator and the second operator.

13. An electronic keyboard device comprising:
the signal generation device according to claim 1; and
a plurality of keys including the first operator and the second operator.

14. An electronic apparatus comprising:
the signal generation device according to claim 1; and
a touch panel controlled to display a plurality of images including a first image corresponding to the first operator and a second image corresponding to the second operator.

15. A signal generation device comprising:
a memory unit storing a program; and
a processor communicatively connected to the memory and executing the program to,
generate a first sound signal corresponding to a first operation of a first operator; and
generate a second sound signal corresponding to a second operation of a second operator following the first operation of the first operator, the second sound signal being generated in a sound generation form based on a duration of the first operation.

16. A signal generation method comprising:
generating a first sound signal corresponding to a first operation of a first operator; and
generating a second sound signal corresponding to a second operation of a second operator following the first operation of the first operator, the second sound signal being generated in a sound generation form based on a duration of the first operation.

17. The signal generation method according to claim 16, wherein generating the second sound signal further includes controlling the sound generation form so as to control a transition time for changing a pitch of the second sound signal from a first pitch corresponding to the first operation to a second pitch corresponding to the second operation.

18. The signal generation method according to claim 17, wherein generating the second sound signal further includes controlling the transition time to be longer in a case where the duration of the first operation is a second duration longer than a first duration of the first operation than in a case where the duration is the first duration.

19. The signal generation method according to claim 17, wherein generating the second sound signal further includes, in a case where the duration of the first operation is shorter than a predetermined time, controlling the transition time to a predefined time corresponding to a case where the control of the sound generation form is disabled

20. The signal generation method according to claim 17, wherein generating the second sound signal further includes, in a case where the duration of the first operation is shorter than a predetermined time and the first operator and the second operator are alternately operated, controlling the transition time to a predefined time corresponding to a case where the control of the sound generation form is disabled.

21. The signal generation method according to claim 20, wherein generating the second sound signal further includes in a case where a number of times the first operator and the second operator are alternately operated reaches a predetermined number of times, controlling the transition time to the predefined time corresponding to the case where the control of the sound generation form is disabled.
